(19) United States
(12) Patent Application Publication
(10) Pub. No.: US 2003/0226605 A1
(43) Pub. Date: Dec. 11, 2003

(54) Multi-port pinch valve and methods of manufacture thereof

(76) Inventor: George S. Raftis II, Pittsburgh, PA (US)

Correspondence Address: WEBB ZIESENHEIM LOGSDON ORKIN & HANSON, P.C., 700 KOPPERS BUILDING, 436 SEVENTH AVENUE, PITTSBURGH, PA, 15219, US

(21) Appl. No.: 10/458,010

(22) Filed: Jun. 10, 2003

Related U.S. Application Data
(60) Provisional application No. 60/387,758, filed on Jun. 11, 2002.

(51) Int. Cl. F16K 11/14

(52) U.S. Cl. 137/869

(57) ABSTRACT

A multi-port pinch valve includes at least one primary conduit section having a bore for containing material transferred therethrough and a plurality of branch conduit sections in fluid communication with the primary conduit section. At least one of the branch conduit sections is defined by a respective branch conduit section wall having an outer sleeve portion, a flexible inner sleeve portion and a gap extending longitudinally along and around a portion of the branch conduit section wall. The gap is positioned between the outer sleeve portion and the inner sleeve portion. The valve also includes an injection mechanism in communication with the gap for injecting a flowing medium into the gap, such that the flexible inner sleeve flexes into a branch conduit bore. Methods of manufacturing the valve and controlling flow in a multi-port pinch valve are also disclosed.

### CROSS REFERENCE TO RELATED APPLICATIONS

This application claims priority from U.S. Provisional Patent Application Serial No. 60/387,758, filed Jun. 11, 2002.

### BACKGROUND OF THE INVENTION

1. Field of the Invention

The present invention relates generally to pinch valve assemblies used in connection with conduit systems for transporting fluids in a conduit system and, in particular, to multi-port pinch valve assemblies for use in such systems and methods of manufacturing these valves.

2. Description of Related Art

In order to move material, such as liquid, to specified or desirable locations, many industries use piping and diverter assemblies in order to safely transport materials. In many situations, such as mixing, diverting flow, unloading trailers and/or other bypass applications, it is desirable to use a one valve assembly with a single inlet port and two outlet ports. Such an assembly would be used in place of two separate valves with a “Y” piping connection between them. A “Y” pipe connection requires many different portions bolted together. In addition, valve assemblies are required that have any number of inlet and outlet ports, dependent upon the configuration and movement of material that is desired.

With respect to a three-ported valve, using a single valve assembly typically reduces installation labor costs and actuator costs, as a single actuator may be used to operate both outlet ports of a valve. While one port is typically closing, the other port is typically opening. However, the disadvantage of such a configuration is that the operating mechanism is somewhat complex. In addition, such a configuration decreases one's ability to independently control flow through the two outlet ports. Such three-port pinch valve assemblies are well known in the art.

In some applications, it is imperative to keep the “pockets” of residual material in the closed port section to a minimum. Using a diverter valve leads to smaller pockets than using two separate valves with a “Y” connection. For example, diverter valves are used extensively in food applications. Since larger pockets can accumulate a great volume of food, such as sugar or flour, such accumulation of food products makes them susceptible to decay. process material through the second section bore; and (d) withdrawing the flowing medium from the gap to retract the inner wall portion and thereby increase flow of the process material through the second section bore.

The present invention, both as to its construction and its method of operation, together with the additional objects and advantages thereof, will best be understood from the following description of exemplary embodiments when read in connection with the accompanying drawings.

### BRIEF DESCRIPTION OF THE DRAWINGS

FIG. 1 is a side sectional and schematic view of a multi-port pinch valve according to the present invention;

FIG. 2 is a perspective view of the multi-port pinch valve of FIG. 1;

FIGS. 3a-3d are side sectional and perspective views of a multi-port pinch valve in operation according to the present invention;

FIG. 4 is a side sectional view of an inner sleeve for a multi-port pinch valve in a first step of manufacture according to the present invention; and

FIG. 5 is a front view of the inner sleeve of FIG. 4.

### DESCRIPTION OF THE PREFERRED EMBODIMENTS

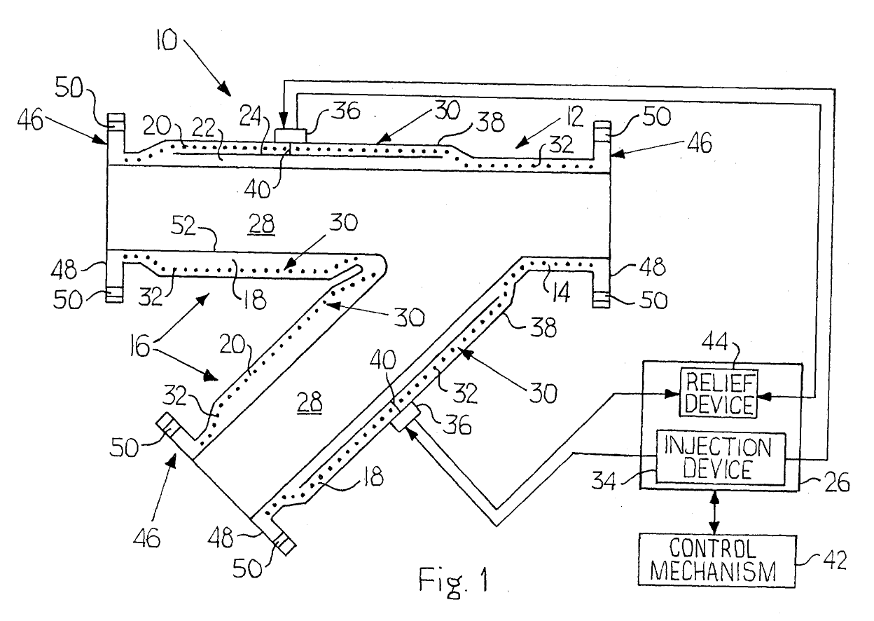

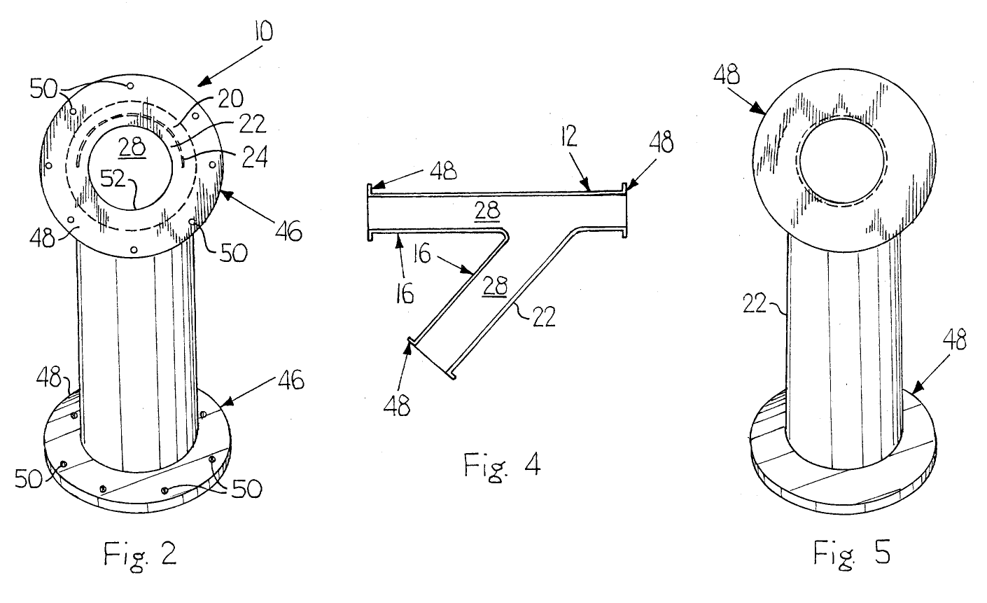

The present invention is directed to a multi-port pinch valve 10, which is illustrated in various stages of assembly and in operation in FIGS. 1-5. As seen in FIG. 1, the multi-port pinch valve 10 includes at least one primary conduit section 12, which is defined by a primary conduit section wall 14, which further defines a bore. This primary conduit section 12 or bore contains material (not shown) that is transferred through the primary conduit section 12 for further movement in a conduit system (not shown). The multi-port pinch valve 10 also includes a plurality of branch conduit sections 16. These branch conduit sections 16 are in fluid communication with the primary conduit section 12, and as with the primary conduit section 12, the branch conduit sections 16 contain material transferred therethrough.

Each of the branch conduit sections 16 are defined by a respective branch conduit section wall 18. Further, the branch conduit section wall 18 has an outer sleeve portion 20, a flexible inner sleeve portion 22 and a gap 24. The gap 24 extends longitudinally along and at least hemi-cylindrically around at least a portion of the branch conduit section wall 18. Further, the gap 24 is positioned between the outer sleeve portion 20 and the inner sleeve portion 22.

In order to effect operation of the multi-port pinch valve, at least one injection mechanism 26 is in communication with the gap 24. The injection mechanism 26 injects a flowing medium, such as gas or fluid, into the gap 24. This causes the flexible inner sleeve portion 22 to expand and flex into a branch conduit section inner area 28 or bore. In this manner, the expansion of the inner sleeve portion 22 into the branch conduit section inner area 28 restricts the flow of material through the branch conduit section 16 and allows for the appropriate control of material flow. In addition, and in order to allow appropriate flexibility in operation, the outer sleeve portion 20 is substantially rigid, while the inner sleeve portion 22 is substantially dynamic.

In order to provide rigidity to the outer sleeve portion 20, the outer sleeve portion 20 may include a reinforcement layer 30. In one preferred and non-limiting embodiment, the reinforcement layer 30 is at least one wire member 32 that extends at least partially around and is in operative communication with (i.e., it is embedded within or wrapped around the outside of) the outer sleeve portion 20. This wire member 32 imparts the required rigidity to the outer sleeve portion 20. It is also envisioned that the reinforcement layer 30 can be constructed of fabric, mesh and/or any other appropriate material having the required rigidity characteristics. In addition, the wire member 32 can be integral with and extend within the outer sleeve portion 20. In creating such a structure, the wire member 32 is formed and bonded with the outer sleeve portion 20.

In order to be flexible and dynamic, the inner sleeve portion 22 should be constructed from a material having the appropriate flexibility and elastomeric properties. For example, the inner sleeve portion 22 can be constructed from an elastomer, rubber, a polymer, or any other flexible material with memory characteristics and of ______ durameter. However, the material of construction of the inner sleeve portion 22 must be able to flex into the branch conduit section inner area 28 when the injection mechanism 26 injects material into the gap 24, and when this material is removed from the gap 24, the inner sleeve portion 22 must return to its original position. The constant flexing of the inner sleeve portion 22 may cause damage to the structure of the inner sleeve portion 22 after repeated use. Therefore, the inner sleeve portion 22 may also include the reinforcement layer 30 in order to provide structural support to the inner sleeve portion 22. However, this reinforcement layer 30 must still allow for the appropriate flexing of the inner sleeve portion 22. In one preferred and non-limiting embodiment, the reinforcement layer 30, for use in connection with the inner sleeve portion 22, is a fabric member that extends at least partially around and is in operative communication with inner sleeve portion 22.

In one preferred and non-limiting embodiment, the injection mechanism 26 includes an injection device 34 that is in communication with a fitting 36, which is connected to an outer surface 38 of a branch conduit section 16. The fitting 36 is in communication with an injection passageway 40, which is, in turn, in communication with the gap 24. In operation, the injection device forces a gas or fluid through the fitting 36, further through the injection passageway 40 and into the gap 24. Accordingly, the gap 24 will expand and flex the inner sleeve portion 22 into the branch conduit section inner area 28, thereby restricting flow through this branch conduit section 16. While the injection mechanism 26 (or injection device 34) typically injects gas, such as air, any suitable fluid such as water or the like may be utilized. In a preferred embodiment, the injection mechanism 26 injects air into the gap 24.

In another preferred embodiment, rather than being manually controlled, the multi-port pinch valve 10 includes a control mechanism 42 in communication with the injector mechanism 26. The control mechanism 42 controls the injection of the gas or liquid into the gap 24. This control mechanism 42 can be in the form of a personal computer, a printed circuit board, a central processing unit, a processing device, a controller, etc. Further, the control mechanism 42 allows an operator to proportionally control the injection of material into the gap 24 of one or more of the branch conduit sections 16.

It is also envisioned that each of the plurality of branch conduit sections 16 has a respective injection mechanism 26 in communication with a respective gap 24. In this embodiment, each injection mechanism 26 is in communication with and controlled by the control mechanism 42, which controls the injection of gas or fluid into each respective gap 24. Again, this can be used for proportional control of each respective branch conduit section 16. For example, an inner sleeve portion 22 of one branch conduit section 16 can be “throttled back,” while another inner sleeve portion 22 of a branch conduit section 16 can be further expanded into the branch conduit section inner area 28. In addition, in order to permit the air or liquid in the gap 24 to be removed from the gap 24, the injection mechanism 26 may also include a relief device 44. This relief device 44 would permit the gas or fluid to be relieved from the gap 24 and either discarded or diverted for further reuse.

In another embodiment, the multi-port pinch valve 10 may include or be formed with one or more connection mechanisms 46 positioned on ends of the branch conduit section 16 and/or the primary conduit section 12. These connection mechanisms 46 would allow the multi-port pinch valve 10 to be connected to other fittings on and throughout the piping or conduit system in a manufacturing facility. In a preferred embodiment, the connection mechanism 46 is a flange 48 positioned on an end of each of the branch conduit sections 16 and the primary conduit section 12. Further, these flanges 48 include bolt holes 50 for securely attaching the multi-port pinch valve 10 to another flange in the conduit system. However, it is envisioned that any suitable connection mechanism 46 can be used, such as a cuff, a clamp, etc.

When using air as the medium for injection by the injection mechanism 26 into the gap 24, an operating air pressure of approximately 30 psi more than the internal line pressure may be required. This would enable the multi-port pinch valve 10 to fully close each branch conduit section 16. Therefore, it is appropriate to use the above-discussed reinforcement layer 30 to suitably reinforce and contain this operating air pressure.

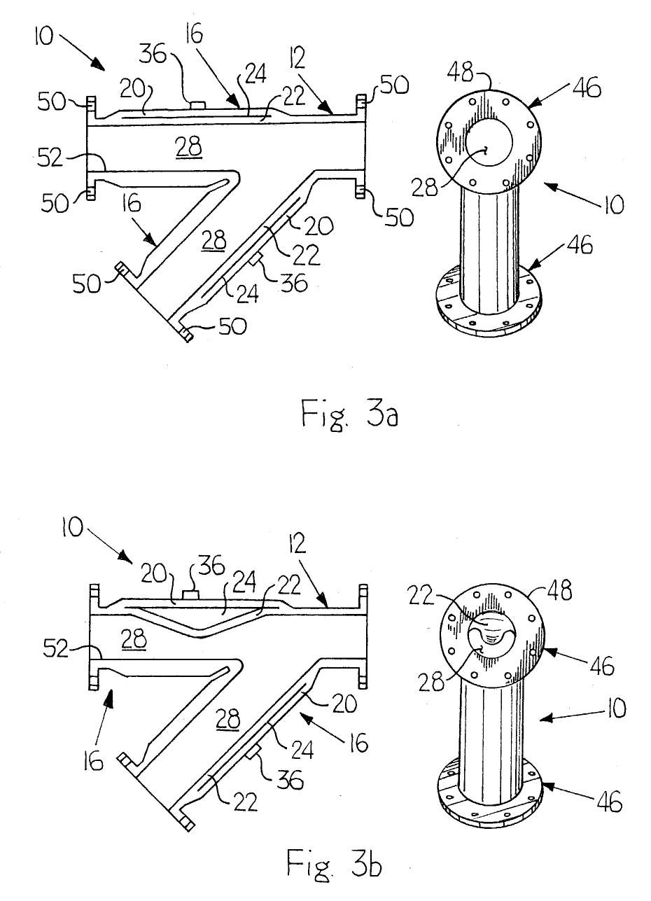

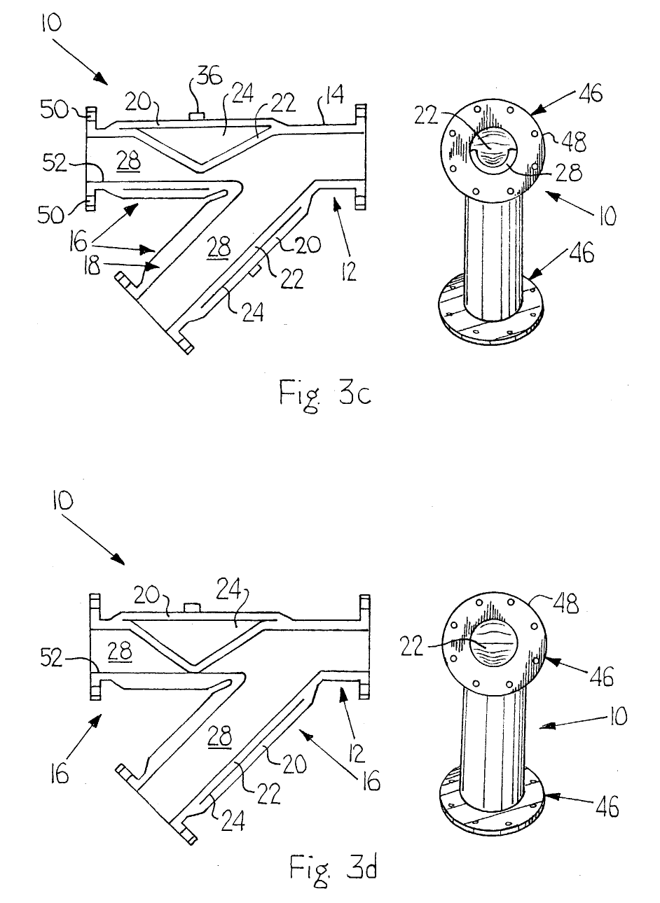

FIGS. 3a-3d illustrate the multi-port pinch valve 10 in operation. Due to the hemi-cylindrical shape of the gaps 24, the outer halves of the inner sleeve portions 22 are capable of being flexed toward the branch conduit section inner area 28 and brought into contact with a branch conduit section opposite wall 52. When such contact occurs, material flow through the “closed” branch conduit section 16 is prevented. See FIG. 3d. The inner sleeve portion 22 is closed from one side, by bulging inward from the full round position. Only about 180 degrees of the circumference bulges inward, due to the positioning of the gap 24. The remaining 180 degrees is fixed to the branch conduit section opposite wall 52. When the branch conduit section 16 in operation is almost fully closed, the opening for the process material or fluid to pass through is about 180 degrees and “C” shaped. In a preferred embodiment, all branch conduit sections 16 operate in this manner.

The present invention is also directed to a method of manufacturing the multi-port pinch valve 10. As seen in FIGS. 4 and 5, a first layer of material is wrapped around a rigid mandrel or form (not shown), thereby creating the inner sleeve portion 22 having a first wall layer defining a primary conduit section 12 and a plurality of branch conduit sections 16. In a preferred embodiment, the form is manufactured from steel or other rigid material, and the first layer of material is a fabric-reinforced elastomer. It is necessary that this inner sleeve portion 22 be capable of flexing. Next, a second layer of material is placed or plied over the first layer of material, thereby creating the outer sleeve portion 20 comprising a second wall layer. The gap 24 is formed between at least a portion of the inner sleeve portion 22 and the outer sleeve portion 20 in one or more of the branch conduit sections 16. Finally, the first and second layers of material are cured.

In order to create the gap 24, a release agent (of a type known to those skilled in the art) may be applied to the desired portion of the inner sleeve portion 22 or first layer of prior to applying the second layer of material. This release agent is used to prevent adhesion between the first and second layers of material during the curing process. When using a rubber material as the primary compound in the inner sleeve portion 22 and the outer sleeve portion 20, the curing process is referred to as a vulcanization process. After vulcanization or curing, and due to the application of the release agent, the gaps 24 or slits are created in the areas where the release agent was used in the branch conduit sections 16. When using the reinforcement layer, such as the wire member 32 or other rigid material, this reinforcement layer 30 is wrapped around the inner sleeve portion 22 or first layer of material prior to application of the second layer of material or outer sleeve portion 20. Thus, after vulcanization or curing, the outer sleeve portion 20 and the wire member 32 form a substantially rigid area. Since the wire member 32 is not formed with the inner sleeve portion 22, the inner sleeve portion 22 remains dynamic and flexible.

In one preferred and non-limiting method of manufacture, after the inner sleeve portion 22, wire member 32 and outer sleeve portion 20 are positioned on the mandrel, the entire multi-port pinch valve 10 is wrapped tightly with an outer pressure material prior to curing. This outer pressure material can be, for example, nylon tape. The purpose of this wrapping is to provide pressure on all layers of material during the vulcanization process. Next, the multi-port pinch valve 10 is placed into a steam pressure vessel and vulcanized into a single solid mass. After vulcanization, which typically requires several hours, the entire multi-port pinch valve 10 is removed from the pressure vessel and allowed to cool. However, it is noted that any manufacturing method for attaining the above-described multi-port pinch valve 10 and its various components is envisioned. Other methods, such as a steel mold, can be used to apply pressure to the multi-port pinch valve 10. Further, as opposed to using the release agent in creating the gap 24, a thin sheet of material, such as Teflon®, may be inserted, which would not bond to the other portions.

While the present invention has described a multi-port pinch valve 10 illustrated with two branch conduit sections 16, any number of branch conduit sections 16 and/or primary conduit sections 12 are envisioned. Any number of flow patterns and material transfer operations can be achieved by using the multi-port pinch valve 10. For example, the branch conduit section 16 and primary conduit section 12 can be switched between being inlets and outlets, with respect to the material flow through the branch conduit section 16 and the primary conduit section 12. For example, such an arrangement could be used in connection with a mixing application with different types of temperatures and material or fluid flowing through individual inlet portions, mixed and flowing through a common or outlet portion. Still further, some branch conduit sections 16 may not require control and may not use or be formed with an outer sleeve portion 20 and a flexible inner sleeve portion 22.

It is also envisioned that any one of the branch conduit sections 16 with a primary conduit section 12 can be constructed with varying bore configurations, for example, a cone sleeve. In this manner, the multi-port pinch valve 10 can be configured having legs of unequal size and with several different bore configurations. For example, one branch conduit section 16 could have a four-inch full-ported bore, and the other branch conduit section 16 could have a two-inch cone-shaped bore. This configuration may be especially useful in the mixing application discussed above.

Overall, the multi-port pinch valve 10 is simple in its construction and easy in its operation. There are no complex mechanical parts, and the branch conduit sections 16 may be operated independently of each other by controlling the amount of operating air pressure applied by the injection mechanism 26, as controlled by the control mechanism 42. Therefore, each branch conduit section 16 may be fully opened, fully closed, or partially closed, independently of the others.

This invention has been described with reference to the preferred embodiments. Obvious modifications and alterations will occur to others upon reading and understanding the preceding detailed description. It is intended that the invention be construed as including all such modifications and alterations.

The invention claimed is:

1. A multi-port pinch valve, comprising:
at least one primary conduit section defined by a primary conduit section wall and having a bore to contain material transferred therethrough;
a plurality of branch conduit sections in fluid communication with the primary conduit section, each having a branch bore to contain material transferred therethrough, at least one of the plurality of branch conduit sections defined by a respective branch conduit section wall having (i) an outer sleeve portion; (ii) a flexible inner sleeve portion; and (iii) a gap extending longitudinally along and around at least a portion of the branch conduit section wall and positioned between the outer sleeve portion and the inner sleeve portion; and
at least one injection mechanism in communication with the gap and configured to inject a flowing medium into the gap, such that the flexible inner sleeve flexes into the branch bore.

2. The multi-port pinch valve of claim 1, wherein the outer sleeve portion is substantially rigid and the inner sleeve portion is substantially dynamic.

3. The multi-port pinch valve of claim 2, wherein the outer sleeve portion includes a reinforcement layer configured to provide rigidity to the outer sleeve portion.

4. The multi-port pinch valve of claim 3, wherein the reinforcement layer is constructed of at least one of wire, fabric and mesh.

5. The multi-port pinch valve of claim 3, wherein the reinforcement layer comprises at least one wire member extending at least partially around and in operative communication with the outer sleeve portion.

6. The multi-port pinch valve of claim 5, wherein the wire member is integral with and extends within the outer sleeve portion.

7. The multi-port pinch valve of claim 2, wherein the inner sleeve portion is constructed from at least one of an elastomer, rubber, a polymer and a flexible material with memory characteristics.

8. The multi-port pinch valve of claim 2, wherein the inner sleeve includes a reinforcement layer configured to provide structural support to the inner sleeve portion.

9. The multi-port pinch valve of claim 8, wherein the reinforcement layer comprises at least one fabric member extending at least partially around and in operative communication with the inner sleeve portion.

10. The multi-port pinch valve of claim 1, wherein the injection mechanism includes an injection device in communication with a fitting connected to an outer surface of a branch conduit section, the fitting in communication with an injection passageway, which is in communication with the gap.

11. The multi-port pinch valve of claim 1, further comprising a control mechanism in communication with the at least one injection mechanism and configured to control the injection of the flowing medum to the gap.

12. The multi-port pinch valve of claim 11, wherein the control mechanism is in the form of at least one of a personal computer, a printed circuit board, a central processing unit, a processing device and a controller.

13. The multi-port pinch valve of claim 1, wherein each of the plurality of branch conduit sections has a respective injection mechanism in communication with a respective gap.

14. The multi-port pinch valve of claim 13, wherein each injection mechanism is in communication with and controlled by a control mechanism configured to control the injection of the flowing medium to each respective gap.

15. The multi-port pinch valve of claim 1, wherein the injection mechanism further comprises a relief device configured to permit the flowing medium to be relieved from the gap.

16. The multi-port pinch valve of claim 1, wherein, in operation, the flowing medium is injected by the injection mechanism into the gap, such that the gap expands and flexes into the branch bore, whereby flow of material through the branch bore is restricted.

17. The multi-port pinch valve of claim 1, wherein the flowing medium to be injected into the gap is selected from one of air and water.

18. The multi-port pinch valve of claim 1, wherein an end of at least one of the plurality of branch conduit sections and the primary conduit section include a connection mechanism configured to connect the end to a further conduit section in a system.

19. The multi-port pinch valve of claim 18, wherein the connection mechanism is at least one of a flange, a cuff, a clamp and a flange with bolt holes.

20. The multi-port pinch valve of claim 1, wherein at least one of the branch conduit section and the primary conduit section have at least one of a different inside diameter, different outside diameter, different shape and different bore configuration.

21. A method of manufacturing a multi-port pinch valve, comprising the steps of:
(a) applying a first layer of material over a form, thereby creating an inner sleeve portion comprising a first wall layer defining a primary conduit section and a plurality of branch conduit sections;
(b) applying a second layer of material over the first layer of material, thereby creating an outer sleeve portion comprising a second wall layer;
(c) forming a gap between at least a portion of the inner sleeve portion and the outer sleeve portion of at least one of the plurality of branch conduit sections; and
(d) curing the first layer of material and the second layer of material.

22. The method of claim 21, wherein the form is a mandrel constructed from at least one of steel and a rigid material.

23. The method of claim 21, wherein the gap is formed by applying a release agent to the portion of the inner sleeve portion prior to applying the second layer of material.

24. The method of claim 21, wherein the gap is formed by positioning a non-adhering material on the portion of the inner sleeve portion prior to applying the second layer of material.

25. The method of claim 21, wherein the curing step comprises vulcanization in a steam process vessel.

26. The method of claim 21, wherein the gap extends longitudinally along and at least hemi-cylindrically around at least a portion of the first layer of material.

27. The method of claim 21, further comprising the step of applying an outer pressure material around the outer layer of material prior to curing.

28. The method of claim 27, wherein the outer pressure material is at least one of nylon tape and an outer form.

29. A method of controlling flow in a multi-port pinch valve, comprising the steps of:
(a) passing a process material from a first section to a second section of the multi-part pinch valve;
(b) injecting a flowing medium into a gap located in a wall of the second section;
(c) extending a portion of an inner wall of the second section adjacent the gap into a second section bore, thereby restricting flow of the process material through the second section bore; and
(d) withdrawing the flowing medium from the gap to retract the inner wall portion and thereby increase flow of the process material through the second section bore.
